(19) United States
(12) Patent Application Publication
(10) Pub. No.: US 2018/0288636 A1
(43) Pub. Date: Oct. 4, 2018

(54) A method for automatic measurement of App load power consumption on mobile devices based on physical measurement

(71) Applicant: Peking University, Beijing (CN)

(72) Inventors: Gang Huang, Beijing (CN); Xuanzhe Liu, Beijing (CN); Hong Mei, Beijing (CN); Mengwei Xu, Beijing (CN); Meihua Yu, Beijing (CN); Yun Ma, Beijing (CN)

(21) Appl. No.: 15/514,686

(22) PCT Filed: Sep. 7, 2016
(86) PCT No.: PCT/CN2016/098294

§ 371 Date: Mar. 27, 2017

(30) Foreign Application Priority Data
Dec. 28, 2015 (CN) 2015110009365

(51) Int. Cl. H04W 24/08

(52) U.S. Cl. CPC H04W 24/08; H04L 43/0864

(57) ABSTRACT

The invention discloses a method for automatic measurement of App load power consumption on mobile devices based on physical measurement. The method includes: 1) sending a designated mobile web and a mobile phone model to a server; 2) the server sends the mobile web to a browser to the corresponding mobile phone to load the mobile web, and starting a power meter; 3) when the mobile web finished loading on the mobile phone, the server processes the measured data: first, obtaining timestamps in the page loading process according to the request time, the reception time, and computation time of network resources, synchronizing the timestamps with the server time, and calculating power consumption of the mobile phone during the mobile web load based on synchronized times and data measured by the power meter. The disclosed method greatly improves the measurement accuracy.

### TECHNICAL FIELD

The present invention relates to the field of computer technology, and in particular, to a method for automatic measurement of App load power consumption on mobile devices based on physical measurement.

### BACKGROUND OF THE INVENTION

“The 21st China Internet Development Statistics Report” shows: mobile phones have become the largest type of Internet terminals. Mobile phone users accounted for 74.5% of the total number of Internet users. As developers more focus on user experience in mobile web development, page load time and load power consumption on the mobile phones have also received developer's attention. For a mobile web, long page load times lead to long user wait times, which results in poor user experience. Excessive power consumption from page load leads to fast battery power loss, overheating, and other issues, which is similarly not conducive to enhance the user experience. Therefore, load power consumption and load time on mobile webs deserve developer's attention.

For the load time, the existing general approach is to directly calculate the load time from a HTTP request to the completion of the browser rendering. For example, load time count starts after a URL is entered in the browser, and stops until the entire page stops changing. This method of estimation takes into account all the steps in the loading process, which is an acceptable measurement scheme when the experimental results are not required to be very precise. For load power consumption, the existing solution is to use the power monitoring interface provided by the Android system, or to estimate with a power consumption model. Power consumption can be roughly estimated using Android power monitoring interface, which is the basis for battery management software on many mobile devices. The power consumption model is based on electricity models at different levels of hardware and software, and then estimates the total power consumption using these electricity models. Both of the above methods of calculating load power consumption are based on software simulation, which cannot meet the need for high accuracy in calculating power consumption in mobile web load.

To address the above problem, a better way for load time measurement is to obtain the load time from the underlying interface of the browser. The loading process of a mobile web may contain multiple HTTP requests. The fine-grained load times obtained at the underlying interface of the browser can show details of these different requests, which allow for detailed analysis of the loading process. For the power measurement, the most direct and accurate approach is based on physical measurements, in conjunction with the fine-grained load times obtained from the underlying interface of the browser, calculations of load power consumption can be further refined. However, even if the above method is technically achievable, such a tool is not generally applicable, because for most developers, physical equipment for power consumption measurement is expensive and the learning cost is too high.

### SUMMARY OF THE INVENTION

To address the problems in conventional technologies, an object of the present invention is to provide a method of automatic measuring power consumption for APP load on mobile devices using physical measurement. The core idea is: using the underlying interface of the browser and a dedicated meter to respectively measure and calculate the load time and the load power consumption of the mobile web. The presently disclosed mobile web applications include APP implemented by using web technologies (such as WebKit) and web applications for browsers.

The technical proposal of the invention is:

A method for automatic measurement of power consumption of loading a mobile web based on physical measurement, including the follow steps:

1) A mobile web developer inputs a designated mobile web and a designated mobile device type into a tool web page; the related data are transmitted to a backend server;

2) The server sends the designated mobile web to a browser running on a mobile phone of the designated mobile device type, and initializes the PowerTool meter to start the measurement;

3) After a period of time, the loading of the mobile web is completed on the mobile phone. The server controls the PowerTool meter to end the measurement, and retrieves all the relevant data;

4) After all the data are processed, the server returns the results to the tool web page in certain format to present to the mobile web developer.

Further, in order to accurately obtain the start and the end time points of a load procedure, in an open source Chrome browser, the lower-layer network request module, render codes for the page module and the js engine are intercepted. A log is added at some specific functional entries and the end point (for example, stamping the request URL with a timestamp before sending a network request, and stamping the URL with another timestamp of the resource in the call back function when the resource is returned). These logs are stored in a dedicated memory buffer, and are finally output to a specified file. Thus one can obtain the request and reception times for each network resource (including html, js, css, and pictures, etc.), and the computation time (js implementation, graphics rendering, etc.). Based on this information, we can resolve the contents of the log, and access fine-grained page loading process and associated timestamps.

The above described process differs from the current technologies: current technologies are dependent on WebView related interface in Android to acquire load time points, or artificially determine load time points using high-speed cameras. The problem is that the WebView module has poor performance, and lacks technical support compared to Chrome. Their experimental results do not have practical significance. The latter approach requires a lot of manpower, and cannot be opened to developer as automated test service.

Further, because power meters and mobile phones have different timing systems, in order to obtain accurate power consumption, it is necessary to synchronize the times of the tested mobile phone and the computer connected to the power meter. The mobile phone sends a TCP request to the power-meter computer in a controlled network environment, and receives a return message. The timestamps at the mobile phone and the power-meter computer in the packet records are analyzed to obtain a time difference between the two time stamps.

Further, the tool chain can be opened to the developer in the form of mobile services, which eliminates the need for hardware support for the mobile web developers. A developer only needs to visit a specific web page, enters a specific URL and a mobile device model, the developer can then obtain load time and power consumption of that web page on that mobile device model.

The invention comprises six key components, namely, a user interface module, a cache automatic update module, core control logic, a data processing module, a meter control module, and a mobile phone control module. Each module needs to complete the function described below.

1. User interface module. The main task of this module is to interact with the user, including acquiring the URL (mobile web) and the model of the mobile phone, and displaying results. The input of the entire tool is very simple; it only needs a URL to be tested and a specific phone model. The output contains analysis results, which is displayed according to the required accuracy.

Since it takes a certain amount of time to measure a web page, and there is limited numbers of testing mobile phones and power meters, multi-user scheduling is needed when there are multiple user requests at the same time.

The simplest approach is first come to first test, that is, if a user request the model is not idle and has been occupied, the user request needs to wait for until measurements of all the URLs in the queue have been completed. This approach ensures a certain degree of fairness.

A more efficient way is to adopt the cache mechanism: each time the user requests a URL and a phone model for measurement, the information and measurement results are recorded in the cache. When other users request the same URL and the phone model, the previously measured data can be directly returned without taking up the test mobile phone and the electricity meter to re-measure. The problem for this strategy is that many web pages are dynamic and have different content at different times.

2. Cache automatic update module. For the above-mentioned dynamic page problem, this module automatically updates the entries in the cache (including the URLs and mobile phone models) during the idle period of the electricity meter, that is, to simulate the user input requests to conduct actual measurements and to update the measurement results in the cache. The update of the entry occurs only when the time interval between the current time and the last update time is greater than a certain threshold. Similarly, if the time interval is greater than the threshold for the real user request, even if there is a matching entry in the cache, measurement is conducted to ensure accuracy and timeliness of the results.

3. Meter control module. The main function of this module is to control the meter switch, and to access power file. The meter usually has some programming interfaces for automatically controlling the meter when to start and when to stop a measurement. During the operation of a power meter, measured data are written into a specific file, such as voltage and current values a specific time.

4. Phone control module. This module uses the debugging tool ADB for Android phones to control the phone through a script. After the URL is obtained by the core logic control block (described below), the phone control module transfers the URL to the preinstalled browser, and the browser starts loading the corresponding page.

Some key points in the process of loading a web page by the browser include the start and the end of the HTTP request. The browser records some logs to the associated file. After the end of the loading process, the phone control module transfers the associated time log file to the core control logic module (described below). It should be noted that mobile phones automatically turn on charging mode when connecting a computer via USB, which will affect the accuracy of the measurement results. Therefore, before a measurement, the charging mode should be turned off in the testing mobile phone by the program, allowing only the power meter to supply power to the mobile phone.

5. Data processing module. This module is responsible for calculating results of time analysis and power analysis based on the contents of the time log file and the power file. The format of the power file is available through the PowerTool user manual, and the format of the time log file is defined by us. The power calculation involves in adding power consumptions at all sample points in a time range to obtain the power consumption in the time range (i.e., a time stamp corresponding to a loading process in the page). After calculating the power of the entire process, the calculation results are returned to the core control logic module (described below) as a JSON array. Since the meter sampling points are very dense, very fine-grained power consumption can be obtained, so as the power consumption during a load.

6. Core control logic module. The main function of this module is to prosecute various steps in the process while coordinating data transfers between other modules. The data transfers include: sending the URL of the web to be measured from the user interface module to the phone control module; transferring the power file and the time log file from the corresponding module to the data processing module; transmitting the processing result in JSON format from the data processing module to the user interface module.

Compared with the prior art, the disclosed invention includes the following benefits:

The method of the invention has the advantages of low cost and high measurement precision, and can measure power consumption at fine granularity in a loading process on a specified device.

### BRIEF DESCRIPTION OF THE DRAWINGS

FIG. 1 is a system block diagram of the disclosed invention.

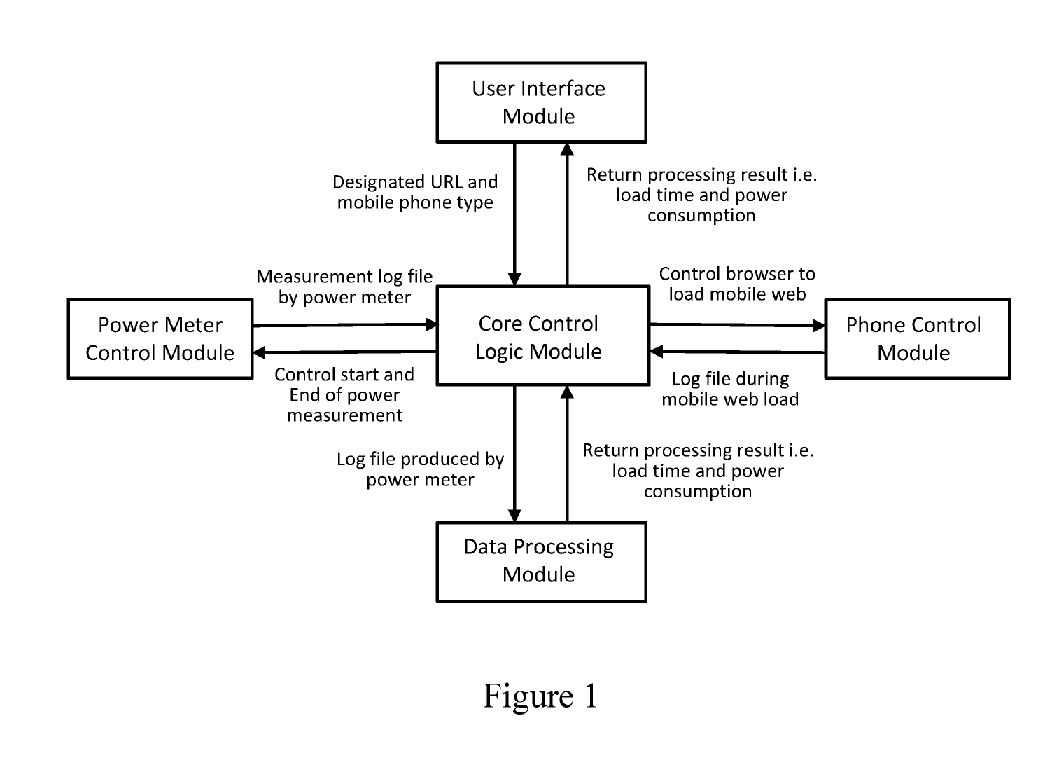

### DETAILED DESCRIPTION OF IMPLEMENTATIONS

This section describes the disclosed test flow using the example measuring power consumption of loading Apple official site at “http:” followed by “//www.apple.com.cn” on a Nexus 5 model.

First, a user enters the above URL on a tool web page and selects the phone model. The user clicks “start test” on the tool web page; the URL and phone model are sent to a server. In this step, the URL is sent from the user processing module to the core control logic module.

If test results for the URL (i.e., Apple's official website) and the phone model (Nexus 5) have been stored in the cache and did not expire, the test results are then directly returned.

Otherwise, the URL will be passed to the phone control module and passed to the pre-installed mobile browser to load. Prior to the load, the core control logic module sends a meter start command to the meter control module. After the power meter has started measurement, the browser starts loading the received URL.

After the loading of the Apple official website page is completed, the core logic control module receives a signal from the phone control module, which indicates the web page has been loaded at this time. The core control module sends another signal to the meter control module to command the meter to stop measurement.

Finally, the core control module retrieves the power file and the time log file and sends these files to the data processing module for calculation. After the calculations are completed, the result is returned to the user interface module and displayed to the user. At this point, the user can view in the Nexus 5 browser accurate time and power that mobile phone took to load Apple's official website.

It can be seen that the whole process is fully automated. Users only need to specify the URL to be tested at the beginning, and can obtain very fine-grained time and power analysis after a period of time.

What is claimed is:

1. A method for automatically calculating power consumption of a mobile terminal based on physical measurement, comprising the steps of:
1) sending a designated mobile web and a mobile phone type to the server;
2) sending the mobile web to a mobile phone of the mobile phone type from the server, running a browser to load the mobile web, and starting a power meter to start measurement, wherein the measurement obtains a measurement result including request time, reception time, and computation time of network resources; and
3) when the mobile web is loaded on the mobile phone, controlling the power meter by the server to end the measurement; processing the measurement result from the measurement: obtaining timestamps for the request time, the reception time, and the computation time of the network resources when the mobile web is loaded, and synchronizing the timestamps with server time; and calculating power consumption by the mobile phone during loading of the mobile web based on timestamps after synchronization and the measurement result by the power meter.

2. The method of claim 1, wherein the request time, the reception time, and the computation time of the network resources in loading the mobile web are obtained by modifying the code of network request module, page rendering module and js engine in the browser.

3. The method of claim 1, wherein the network resources comprise html, js, css, and pictures.

4. The method of claim 3, wherein the computation time comprises js execution time and graphics rendering time.

5. The method of claim 1, wherein the mobile phone is connected to the server via a USB, the method further comprising:
turning off charging mode of the mobile phone by the server before the measurement is started; and
supplying power only from the power meter.

6. The method of claim 1, wherein the step of synchronizing the timestamps with time of the server comprises: in step 1), sending a TCP request from the mobile phone to the server in a controlled network environment, receiving a return data packet from the server, and obtaining a time difference between the mobile phone and the server based timestamps recorded in the data packet, and in step 3) synchronizing the timestamps relative to the server time based on the time difference.

7. The method of claim 1, further comprising:
caching the data from the measurement in a cache by the server; and
automatically updating entries in the cache, wherein the entry each comprises a mobile web, a mobile model type, and measurement result.

8. The method of claim 7, wherein the step of automatic updating is conducted when a time interval between current time and a last update time is greater than a certain threshold for an associated entry, wherein the step of automatic updating comprises: reloading the mobile web on a mobile phone of the designated mobile phone type, and updating measurement result in the cache.
